(19) United States
(12) Patent Application Publication
(10) Pub. No.: US 2026/0285241 A1
(43) Pub. Date: Sep. 24, 2026

(54) RETRACTABLE PROTECTIVE SURFACE FOR VEHICLE INTERIORS

(71) Applicant: STEPHEN T. VASTINE, MESQUITE, TX (US)

(72) Inventor: STEPHEN T. VASTINE, MESQUITE, TX (US)

(21) Appl. No.: 19/359,143

(22) Filed: Oct. 15, 2025

Related U.S. Application Data
(60) Provisional application No. 63/773,609, filed on Mar. 18, 2025.

(51) Int. Cl. B60J 11/06

(52) U.S. Cl. CPC B60R 13/011; B60R 13/01; B60R 2013/015; B60R 2013/018

(57) ABSTRACT

Retractable protective surface configured for reversible installation on an interior surface of a vehicle. The retractable protective surface is formed from a plurality of sections composed of substantially rigid materials that may support items loaded into a vehicle. The plurality of sections may fold or unfold upon each other to provide the desired area of coverage.

### CITATION TO PRIOR APPLICATIONS

The present application claims priority to U.S. Provisional Application No. 63/773,609, titled “RETRACTABLE PROTECTIVE SURFACE FOR VEHICLE INTERIORS” and filed on Mar. 18, 2025, which is, along with all references therein, entirely incorporated by reference herein

### BACKGROUND AND SUMMARY

Both personal and commercial vehicles are regularly used to transport items and materials that may cause damage or undue wear on the vehicle. This is particularly true when transporting objects within an interior compartment of a vehicle which is often covered with a more delicate material than that of the vehicle's exposed exterior surfaces.

While there are conventional vehicle liners that provide some degree of protection to vehicle surfaces, these conventional solutions are cumbersome to install, remove, and maintain. Additionally, such solutions must often be very specifically manufactured to fit the precise dimensions of a particular vehicle.

The present disclosure provides an improved, retractable system to provide enhanced protection to vehicle surfaces while simultaneously facilitating easier system maintenance.

Non-limiting, exemplary embodiments of this system are depicted in the accompanying figures.

### BRIEF DESCRIPTION OF THE DRAWINGS

The preceding aspects and many of the attendant advantages of the present disclosure will become more readily appreciated by reference to the following Detailed Description when taken in conjunction with the accompanying drawings of example embodiments. The drawings briefly described below are presented for ease of explanation and do not limit the scope of the claimed subject matter.

FIG. 1 depicts a top view of a folded protective system in accordance with embodiments of the present disclosure.

FIG. 2 depicts a top view of an unfolded protective system in accordance with embodiments of the present disclosure.

FIG. 3 depicts a perspective view of a folded protective system in accordance with embodiments of the present disclosure.

FIG. 4 depicts a perspective view of an unfolded protective system in accordance with embodiments of the present disclosure.

FIG. 5 depicts a perspective view of an unfolded protective system in accordance with embodiments of the present disclosure.

FIG. 6 depicts a perspective view of a folded protective system disposed in a vehicle in accordance with embodiments of the present disclosure.

FIG. 7 depicts a perspective view of an unfolded protective system disposed in a vehicle in accordance with embodiments of the present disclosure.

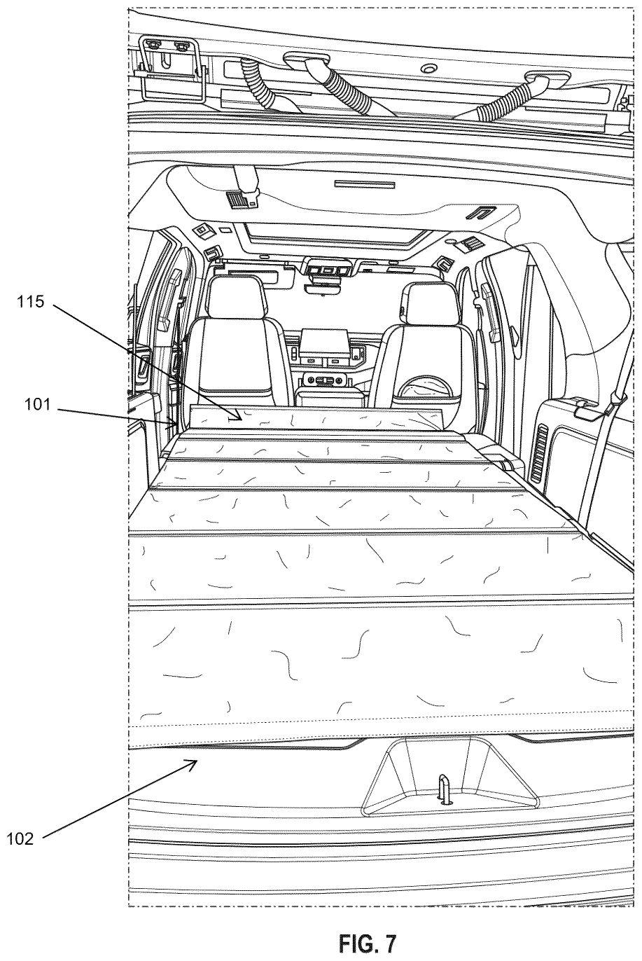

FIG. 8 depicts a top view of sections of a protective system in accordance with embodiments of the present disclosure.

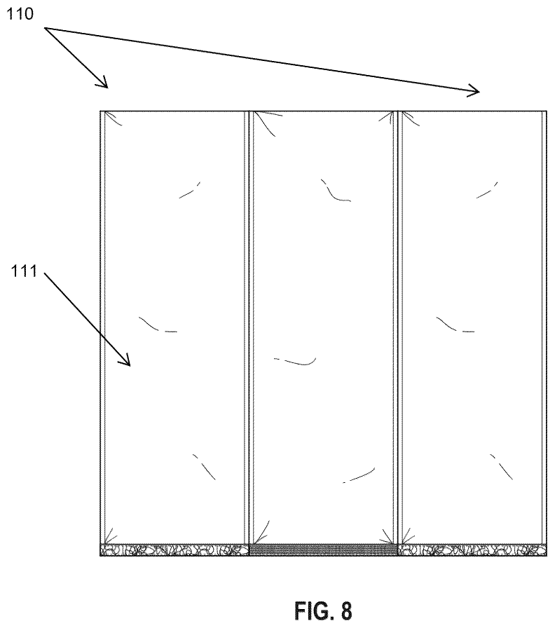

FIG. 9 depicts a top view of a section of a protective system in accordance with embodiments of the present disclosure.

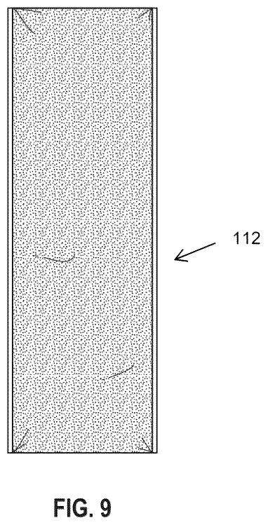

FIG. 10 depicts a top view of a section of a protective system having a removable panel in accordance with embodiments of the present disclosure.

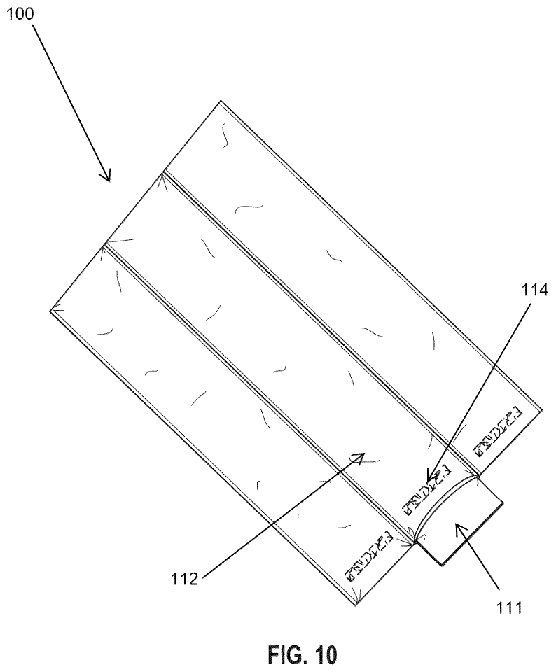

FIG. 11 depicts a perspective view of an unfolded protective system having a flexible extension and disposed in a vehicle in accordance with embodiments of the present disclosure.

FIG. 12 depicts a perspective view of an unfolded protective disposed in a vehicle system having a flexible extension and in accordance with embodiments of the present disclosure.

FIG. 13 depicts a perspective view of an unfolded protective system having a flexible extension and disposed in a vehicle in accordance with embodiments of the present disclosure.

FIG. 14 depicts a perspective view of an unfolded protective system having a flexible extension and disposed in a vehicle in accordance with embodiments of the present disclosure.

FIG. 15 depicts a perspective view of an unfolded protective system in accordance with embodiments of the present disclosure.

### DETAILED DESCRIPTION

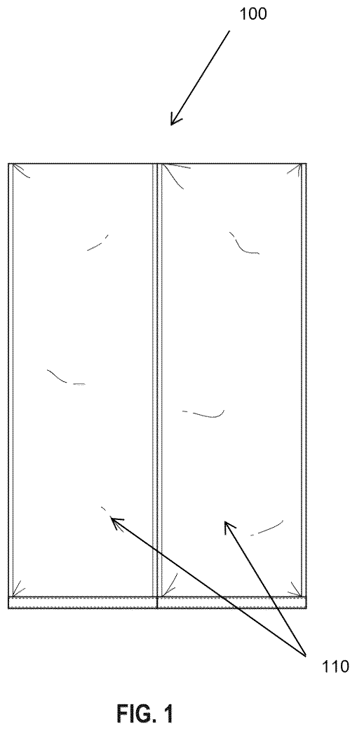

As shown in FIG. 1, in some embodiments of the present disclosure, the protective system 100 comprises a plurality of sections 110. Each section 110 of the plurality of sections may be a panel formed to be substantially rigid from conventionally known materials used to provide protection and support to surfaces designated for the disposition of items having a broad range of sizes and weights. The number and size of sections 110 may vary as needed to accommodate a vehicle. In some embodiments, the surface of the respective faces of each section may comprise different materials. For example, in one embodiment, system 100 may comprise sections having one face with a textured surface configured to reduce movement of any objects place thereon and another face with a substantially waterproof surface to provide enhanced protection of a vehicle's interior during transportation. Notably, in such embodiments, the system is substantially reversible in that either face may be used by orienting it upward relative the vehicle's interior bottom surface depending on the user's particular needs.

In other embodiments, each section 110 within the plurality of sections may comprise a panel assembly wherein the panel assembly comprises an interior panel 111 to provide enhanced durability and support for the assembly and a housing 112 for the interior panel. This housing 112 may be fabricated using conventionally known materials capable of being formed to receive such an interior panel.

The housing 112 may be comprised of a substantially non-rigid material to form essentially a sleeve into which the interior panel 111 is inserted. The sleeve may have one open end adapted to receive the interior panel 111. This open end 113 may be configured for reversible engagement. For example, corresponding Velcro strips 114 may be disposed within the sleeve on opposing surfaces such that the strips may be engaged with one another while having the interior panel disposed within the sleeve. This design allows for installation and removal of the interior panel 111 to permit cleaning or maintenance of the sleeve.

The interior panel 111 may be composed of a substantially rigid material configured to provide structural support for the panel assembly and further inhibit penetration of the panel assembly to protect the underlying vehicle surface. An exemplary material may be any such substantially rigid material conventionally known in the art.

The number of dimensions of each section 110 (and consequently the dimensions of the sleeves and interior panels) may be adapted to accommodate vehicles of different sizes.

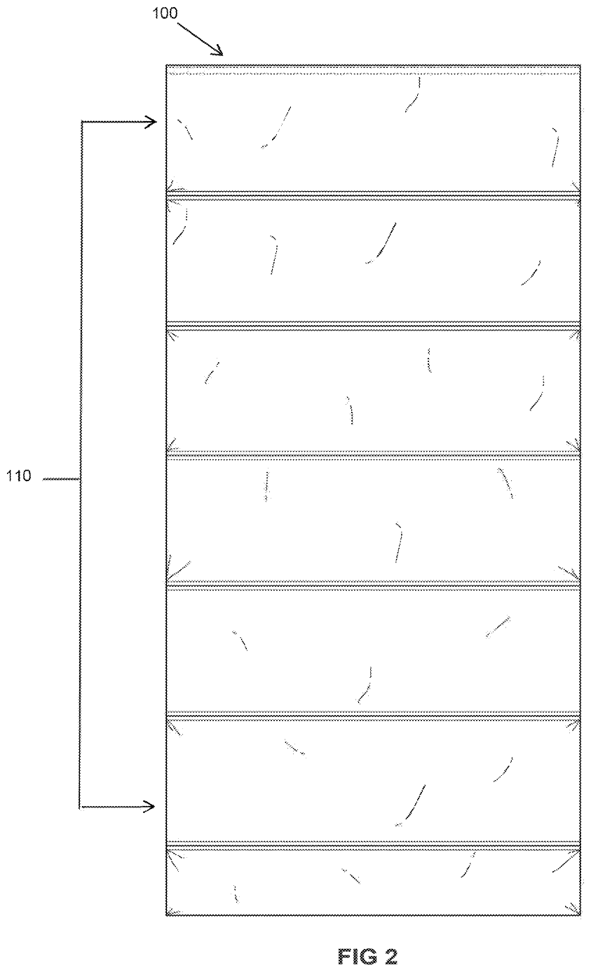

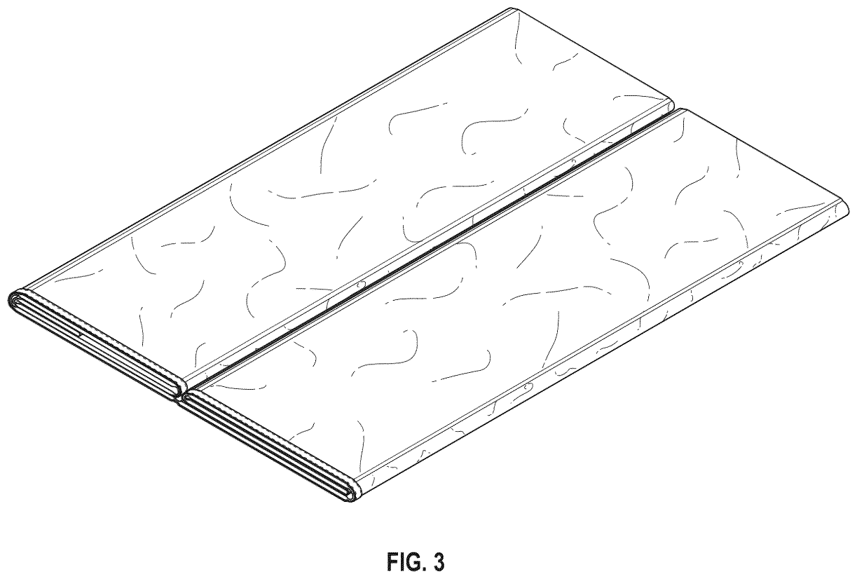

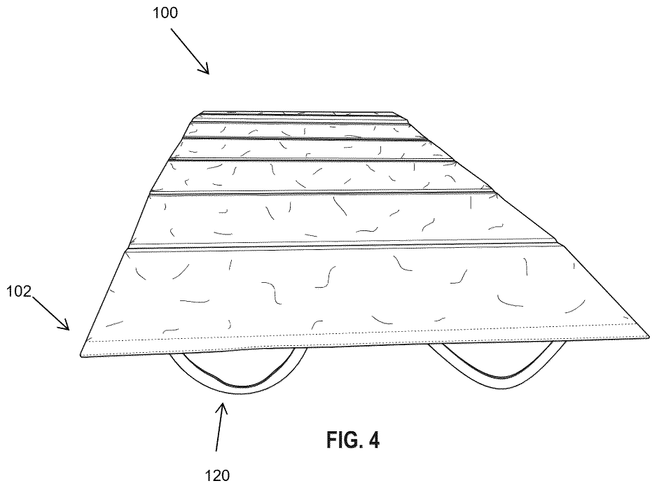

As shown in FIGS. 1, 3, and 6, in some embodiments, the system may be folded upon itself to reduce the space taken in the vehicle. This provides flexibility in the number of sections used at any given time. A common configuration of higher capacity personal vehicles (such as those having three rows of seats) is to keep the rearmost row of seats lowered to provide additional storage space. At other times, all or none of the rear seats may be lowered. The presently disclosed system permits a user to adjust the number of sections used to accommodate each of these seat configurations. The system may be unfolded as depicted in FIGS. 2, 4, 5, and 11 when the vehicle interior itself is configured to provide adjustable amounts of space that require coverage.

Sections 110 may be substantially permanently engaged to one another via conventional methods. In some embodiments, the panels are sewn together. In such embodiments, sections 110 may be biased along the seams between the respective sections.

In further embodiments, the panels may be reversibly engaged to one another via conventional methods. Such embodiments may utilize clasps, frictional fits, exterior Velcro strips, or other similar mechanisms. Such mechanisms may be configured not to prevent folding of the sections onto each other when the mechanisms are engaged.

One section at one end 102 of the system may comprise a grip portion 120 configured to accommodate a user's hand or hands. An exemplary grip portion 120 is shown in the figures as being formed into the material of the relevant section. In other embodiments, the grip portion 120 may be disposed on a surface or surfaces of a section.

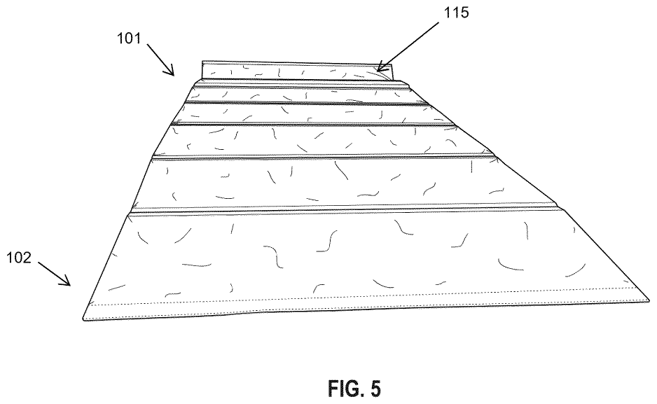

As depicted in FIGS. 2 and 5, a terminal section at an opposite end 101 of the system may comprise a barrier or flap portion 115 configured to rest against a vehicle structure or surface to inhibit objects disposed on the system from becoming otherwise displaced in the vehicle (such as falling underneath the system when the system is placed over folded seats).

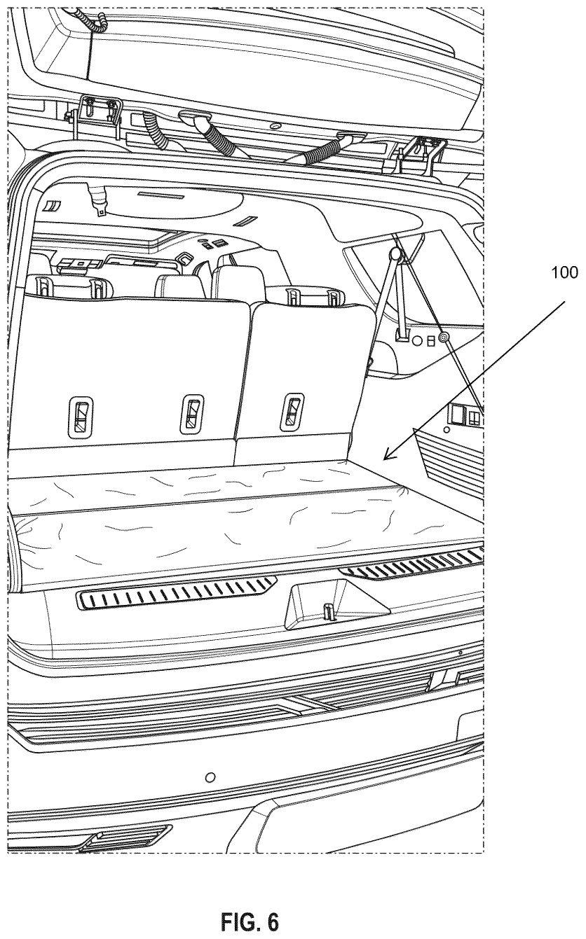

During deployment, system 100 may be initially placed into the vehicle in a substantially compact or folded state as shown in FIG. 6. This compact state provides surface protection via the exposed sections 110 disposed in the vehicle. When additional surface area protection is needed, the system may be unfolder to extend further into the vehicle. For ease of installation and removal, the system may be configured to slide against the underlying vehicle surface when force is applied in a direction perpendicular to the surface(s) of the system disposed parallel to the underlying vehicle surface. The system may permit sliding even when objects are disposed on the system.

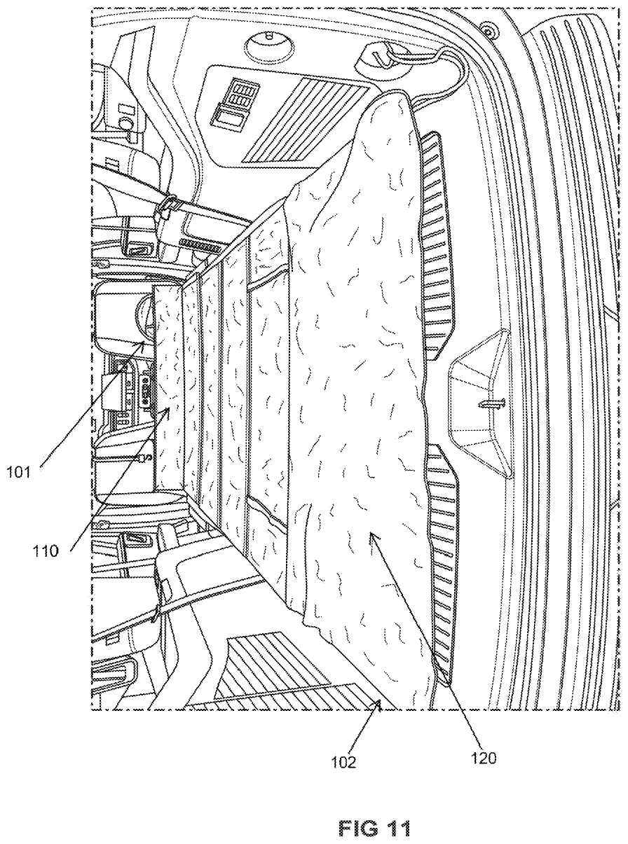

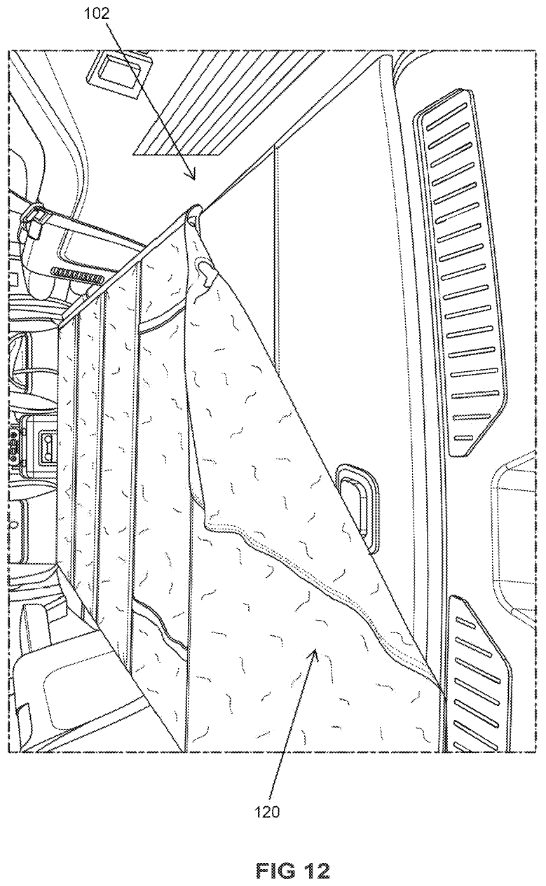

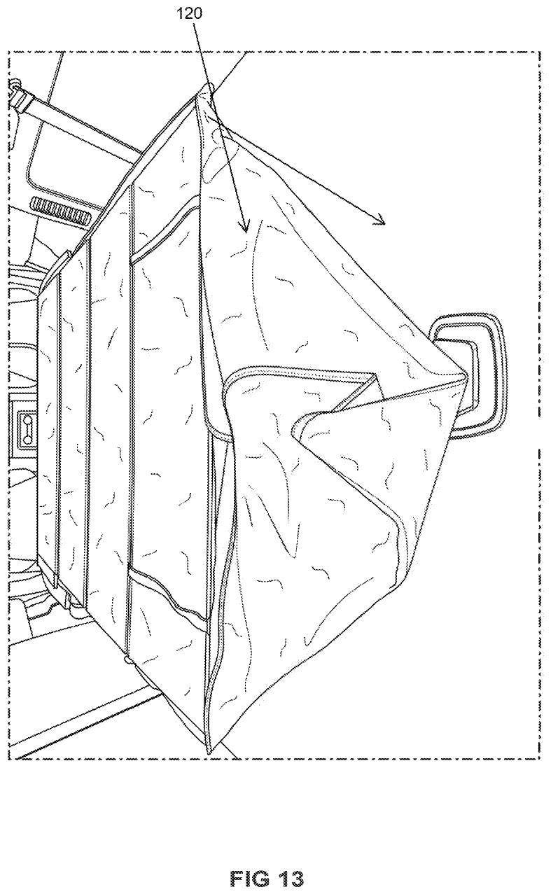

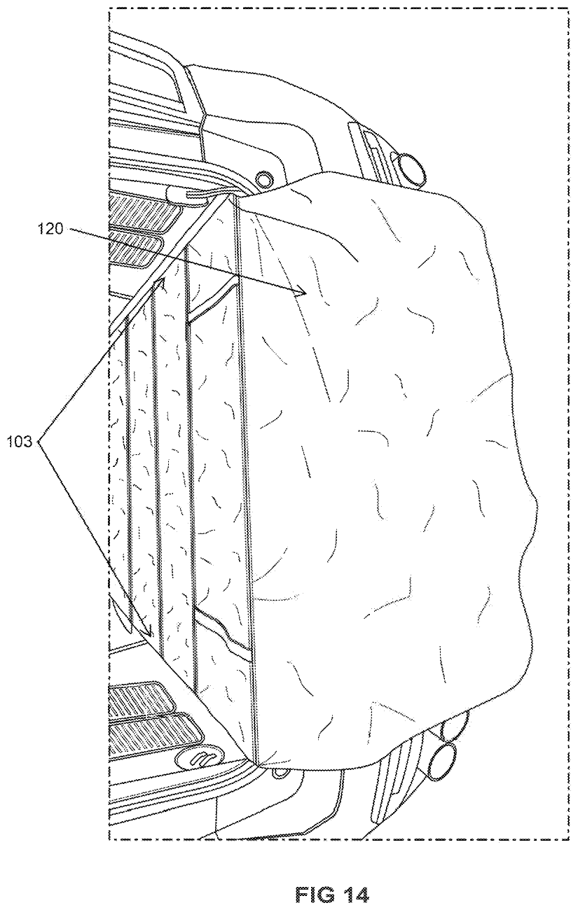

Further embodiments are depicted in FIGS. 11-14. Similar to other embodiments disclosed herein, the system 100 comprises a plurality of sections 110. In certain embodiments, the plurality of sections comprises at least three sections 110. Given the common dimensions of personal vehicles, embodiments having between 3-6 sections may provide greatest convenience and functionality to typical users. These sections 110 may be configured and fabricated as described with respect to earlier embodiments.

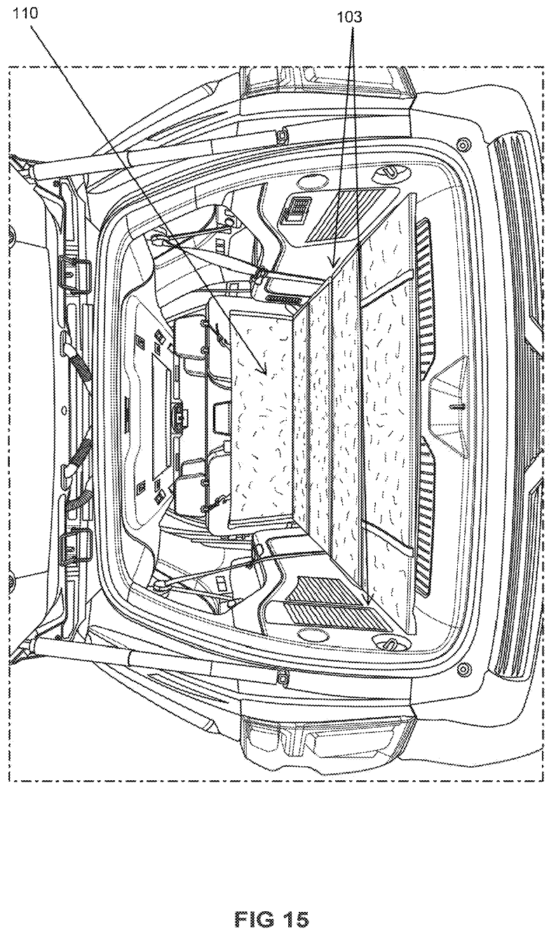

Shown in FIGS. 11 and 15, the system 100 may have a first end 101 that is disposed toward the front of a vehicle and a second end 102 substantially opposite first end 101. The system 100 may be configured to permit a section 110 toward first end 101 to be biased such that it rests along the backs of any seats in the vehicle thereby providing additional protection of and separation of the occupied portion of the vehicle from any items disposed on the system 100. This configuration may accommodate at least a vehicle having all or only some of its rear seats recessed.

As seen in FIGS. 11-14, the system 100 may comprise a substantially non-rigid or flexible portion at the second end 102 of the system 100 to provide an additional protective surface area 120 and facilitate installation and removal of the system 100 from the vehicle. The additional protective surface 120 may be a substantially non-rigid or flexible material that is formed or attached substantially permanently (or removably) by such conventional means including those previously mentioned in relation to the attachment of sections 110.

In further embodiments, substantially non-rigid or flexible extensions may be formed or attached along the edges 103 of the system 100 between the first end 101 and second end 102 to provide enhanced flexibility in the types of vehicles the system 100 can accommodate and the placement of the system 100 in such vehicles. Each extension may be configured to run along substantially the entire length of an edge 103. In other embodiments, each extension may be configured for attachment to a section 110 and to run along the edge of that section.

In addition, in the preceding description, it can be seen that various features may be grouped in a single embodiment to streamline the disclosure. This method of disclosure is not to be interpreted as reflecting an intention that any claimed embodiments require more features than are expressly recited in each claim. Instead, as the claims reflect, the relevant subject matter lies in less than all features of a single disclosed embodiment. Accordingly, the description should not be interpreted as necessarily limiting the scope of this disclosure only to expressly described embodiments.

What is claimed is:

1. A retractable protective system comprising:
a plurality of sections composed of a substantially rigid material, wherein said plurality of sections is configured for disposition upon an interior surface of a vehicle, wherein each section of said plurality of sections is configured to bias along a respective section edge disposed between said each section of said plurality of sections; and
a substantially non-rigid extension section positioned at one end of said plurality of sections.

2. The retractable protective system of claim 1 wherein said plurality of sections comprises at least three sections, wherein said each section is attached to another section along said respective section edge.

3. The retractable protective system of claim 2 wherein said each section is attached by sewing along said respective section edge.

4. The retractable protective system of claim 1 wherein each said section comprises a panel assembly, said panel assembly comprising a substantially rigid panel and a sleeve, wherein said sleeve is adapted to reversibly receive said panel.

5. The retractable protective system of claim 4 wherein said panel assembly further comprises a closed end and an open end, wherein said panel is reversibly received at said open end, wherein said panel is substantially fully enclosed within said sleeve when received.

6. A method for protecting an interior surface of a vehicle comprising:
positioning upon an interior surface of a vehicle a section assembly comprising plurality of sections composed of a substantially rigid material and a substantially non-rigid extension section positioned at one end of said plurality of sections, wherein said plurality of sections is configured for disposition upon said interior surface of said vehicle, wherein each section of said plurality of sections is configured to bias along a respective section edge disposed between said each section of said plurality of sections, wherein said substantially non-rigid extension section of disposed proximal the rear of said vehicle, wherein said section assembly is oriented within said vehicle to permit biasing of at least one section of said plurality of sections away from said substantially non-rigid extension section along a length of said interior surface; and
biasing said at least one section of said plurality of sections away from said substantially non-rigid extension section.

7. The method of claim 6 further comprising disposing a first section positioned substantially opposite said substantially non-rigid extension section of said plurality of sections against a back portion of at least one seat in said vehicle by biasing said first section away from said substantially non-rigid extension section.

8. The method of claim 6 wherein said plurality of sections comprises at least three sections.

9. The method of claim 8 further comprising biasing each section of said at least three sections away from said substantially non-rigid extension section.

10. The method of claim 9 further comprising disposing a first section positioned substantially opposite said substantially non-rigid extension section of said plurality of sections against a back portion of at least one seat in said vehicle by biasing said first section away from said substantially non-rigid extension section.
